(19) United States
(12) Patent Application Publication
(10) Pub. No.: US 2022/0175611 A1
(43) Pub. Date: Jun. 9, 2022

(54) CUP ATTACHMENT FOR MASSAGER

(71) Applicant: Pado, Inc., Valencia, CA (US)

(72) Inventors: Steven Lee, Valencia, CA (US); Alejandro Garfio, Mission Viejo, CA (US)

(73) Assignee: Pado, Inc., Valencia, CA (US)

(21) Appl. No.: 17/547,154

(22) Filed: Dec. 9, 2021

Related U.S. Application Data
(60) Provisional application No. 63/123,410, filed on Dec. 9, 2020.

(51) Int. Cl. A61H 9/00; A61H 31/00; A61H 23/00

(52) U.S. Cl. CPC A61H 9/0057; A61H 9/0071; A61H 31/00; A61H 23/006; A61H 2201/1621; A61H 2201/0153; A61H 2031/001; A61H 2201/1626; A61H 2009/0064

(57) ABSTRACT

Systems and methods described herein relate to a cup attachment for an electric percussive massager. The cup attachment may be configured for use in performing cupping therapy on a recipient using the massager. The cup attachment may include a cup region and an inner frame. The cup attachment may be made out of a flexible material. The inner frame may be made out of a rigid material. The cup attachment may include a ring portion which may deliver a direct-force cupping therapy when applied to a recipient. The cup attachment may also include a cavity which may deliver an indirect-force, air-pressure-based, cupping therapy when applied to a recipient.

### CROSS-REFERENCE TO RELATED APPLICATION

This application claims the benefit of U.S. Provisional Application No. 63/123,410 filed on Dec. 9, 2020, which is hereby incorporated herein by reference in its entirety.

### TECHNICAL FIELD

The disclosed technology relates generally to massagers, and more particularly, some embodiments relate to a cup attachment for a massager.

### DESCRIPTION OF RELATED ART

Cupping for respiratory therapy has many benefits for the recipient. In some implementations, cupping creates a negative pressure via vacuum suction to help reduce congestion in the recipient's lungs by increasing blood and lymph flow to the cupping area. The recipient's lungs receive fresh oxygenated blood and essential nutrients, and lymph cleanses the cupping area of cellular debris and other impurities.

One technique for performing cupping in respiratory therapy is for the therapist to cup his or her hand, and then tap on the recipient's back and/or chest to loosen mucus in the lung area. By cupping the hand, the therapist traps air in the cupped hand. When the therapist delivers a blow to the back or chest, a combination of the hand and the air trapped in the hand causes a deeper impact on the lung with less discomfort to the skin.

### BRIEF SUMMARY OF THE DISCLOSURE

According to various embodiments of the disclosed technology, there is disclosed a cup attachment for an electric percussive massager, the cup attachment configured for use in performing cupping therapy on a recipient using the massager.

According to an embodiment of the disclosed technology, the cup attachment comprises a cup region made of a flexible material such as rubber or an artificial elastomer, and an inner frame made of a rigid material such as acrylonitrile butadiene styrene (ABS) or another thermoplastic polymer.

In one embodiment, the cup region comprises a ring portion configured to apply a direct force to the skin of the recipient, and a cavity portion formed within the ring portion and configured to apply an indirect force to the skin of the recipient through air pressure. The ring portion may comprise a circular lip at the bottom edge of the ring portion for engaging a circumferential edge of the inner frame.

In one embodiment, the cavity portion may comprise a substantially cylindrical sidewall extending away from the ring portion and a substantially circular bottom wall connected to the sidewall opposite the ring portion. In another embodiment, the cavity portion may be bowl shaped, with the sidewall sloping away from the ring portion to a flat bottom wall. A circular engagement feature may be formed on the bottom of the bottom wall (on the side facing the inner frame) for engaging a corresponding circular engagement feature on the inner frame.

In one embodiment, the cup region is approximately 6 cm in diameter, and the cavity portion is approximately 3 cm in diameter.

In one embodiment, the inner frame comprises a substantially circular body that bends away from the cup region in order to present a convex surface to the cup region. The inner frame may also comprise a plurality of strengthening ribs that extend radially outward from the engagement feature on the inner frame. The inner frame have further comprise a fastening means, such as a threaded fastener or screw, for releasably attaching the inner frame (and thus the cup attachment) to an electronic percussive massager.

In one embodiment, the cup attachment is configured to be percussed back and forth at an amplitude of from approximately 3 mm to approximately 20 mm.

In one embodiment, the cup attachment is configured to be percussed back and forth at a frequency of from approximately 20 Hz to approximately 50 Hz.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates a first example of a massage device model having a plurality of interchangeable attachments, in accordance with one embodiment of the systems and methods described herein.

FIG. 1B illustrates a second example of a massage device model having a plurality of interchangeable attachments, in accordance with one embodiment of the systems and methods described herein.

FIG. 1C illustrates a third example of a massage device model for purposes of comparison with one embodiment of the systems and methods described herein.

FIG. 2 illustrates an example of a massage system having a plurality of interchangeable attachments, in accordance with one embodiment of the systems and methods described herein.

FIG. 3A is an example of a front view of a cup attachment in accordance with one embodiment of the systems and methods described herein.

FIG. 3B is an example of a rear view of a cup attachment in accordance with one embodiment of the systems and methods described herein.

FIG. 4A is an example of a rear view of a cup region for use with a cup attachment, in accordance with one embodiment for the systems and methods described herein.

FIG. 4B is an example of a front view of a cup region for use with a cup attachment, in accordance with one embodiment for the systems and methods described herein.

FIG. 5A is an example of a front view of an inner frame for use with a cup attachment, in accordance with one embodiment for the systems and methods described herein.

FIG. 5B is an example of a rear view of an inner frame for use with a cup attachment, in accordance with one embodiment for the systems and methods described herein.

The figures are not exhaustive and do not limit the present disclosure to the precise form disclosed.

### DETAILED DESCRIPTION

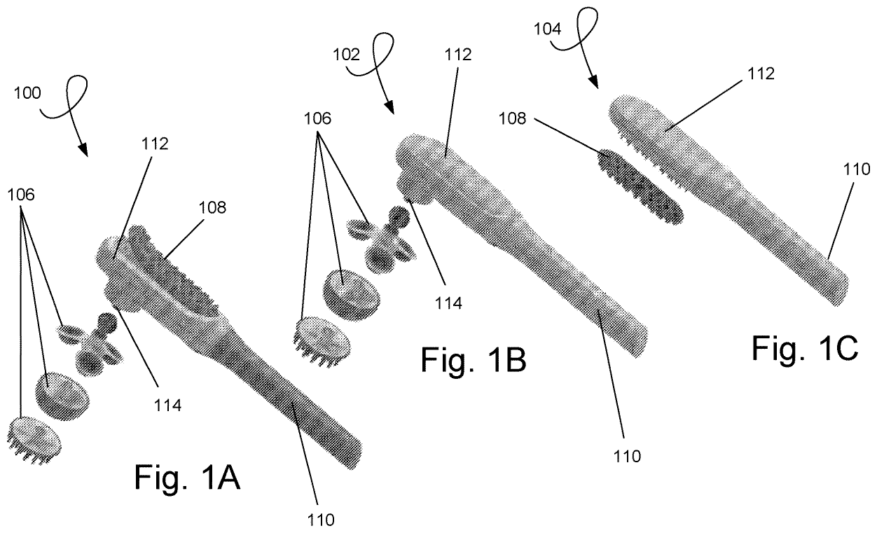

FIGS. 1A, 1B, and 1C illustrate examples of massage devices. FIG. 1A shows an example of a massage device 100 configured for both percussion and vibration modes. As shown in FIG. 1A, the massage device 100 may include a handle portion 110 and a head portion 112 connected to the handle portion 110. A vibrational massage portion 108 may be attached to one side of the massage head portion. The head portion 112 may also include an attachment portion 114. The attachment portion 114 may be a threaded hole on the other side of the head portion 112. The attachment portion 114 may also be a screw. The attachment portion 114 may also be a magnetic connector. The attachment portion 114 may also be a suction chamber configured to accept a complementary rod. The massage device 100 may also include removable attachments 106. Each of the removable attachments may be attached to the massage device 100 at the attachment portion 114. One of the removable attachments 106 may be a cup attachment.

FIG. 1B shows an example of a massage device 102 configured only for percussion. As shown in FIG. 1B, the massage device 102 may include a handle portion 110 and a head portion 112 connected to the handle portion 110. The head portion 112 may include an attachment portion 114. The massage device 102 may also include removable attachments 106. Each of the removable attachments may be attached to the massage device 102 at the attachment portion 114. One of the removable attachments 106 may be a cup attachment.

FIG. 1C shows an example of a massage device 104 configured only for vibration. As shown in FIG. 1C, the massage device 104 may include a handle portion 110 and a head portion 112 connected to the handle portion 110. A vibrational massage portion 108 may be attached to one side of the massage head portion.

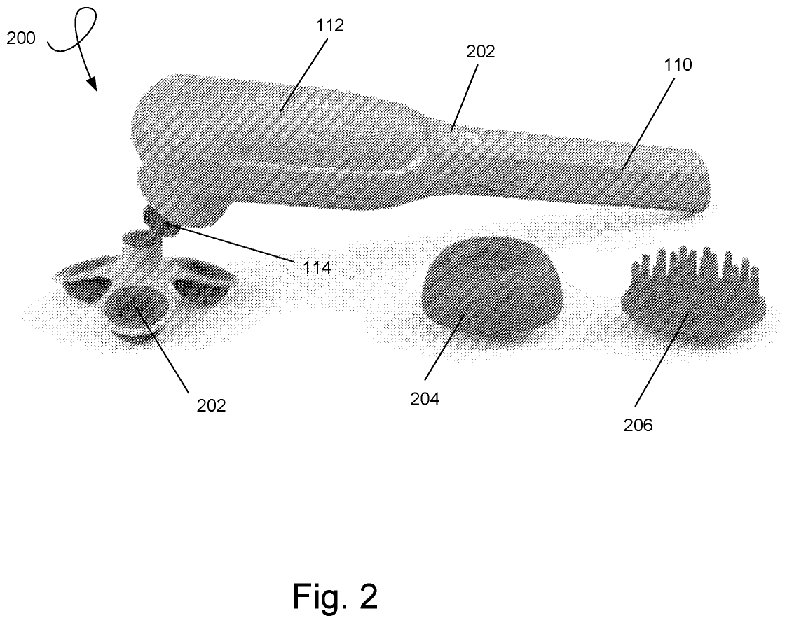

FIG. 2 illustrates an example of a massage system 200. As shown in FIG. 2, the massage system 200 may include a massage device 202. The massage device 202 may include a handle portion 110 and a head portion 112 connected to the handle portion 110. The head portion 112 may include an attachment portion 114. The massage device 202 may also include removable attachments. For example, the removable attachments may include a multi-headed attachment 202, a cup attachment 204, and a brush attachment 206. Other types of attachments may be possible. Each of the removable attachments may be attached to the massage device 202 at the attachment portion 114.

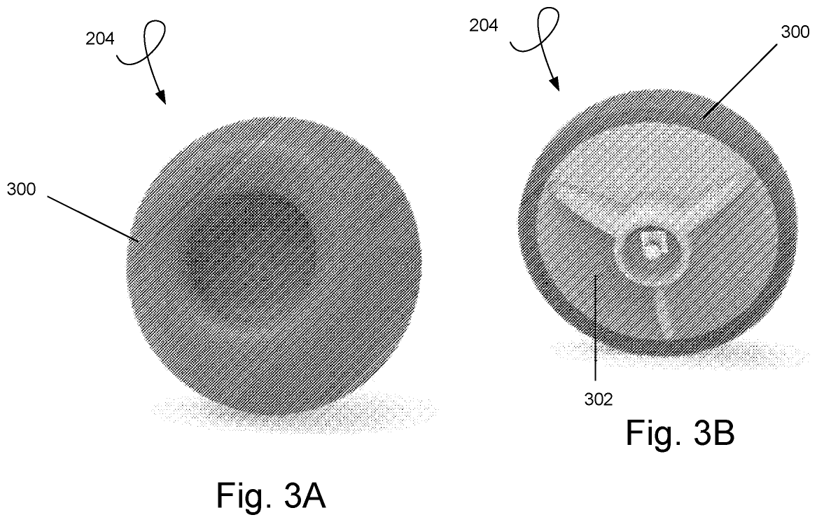

FIGS. 3A and 3B illustrate front and rear views of an example of a cup attachment 204, respectively. As shown in FIG. 3A, the cup attachment 204 may include a cup region 300. The cup region 300 may be made out of a flexible material. The flexible material may be natural or artificial. For example, in one embodiment the cup region 300 may be made out of rubber. In another example embodiment, the cup region 300 may be made out of an artificial elastomer.

As shown in FIG. 3B, the cup attachment 204 may include a cup region 300 and an inner frame 302. The cup region 300 may be attached to the inner frame 302. The cup region 300 may be fitted around the inner frame 302 and/or may surround the inner frame 302. The inner frame 302 may be made out of a rigid material. For example, the rigid material may be a thermoplastic polymer. In one example embodiment, the inner frame 302 may be made out of acrylonitrile butadiene styrene (ABS).

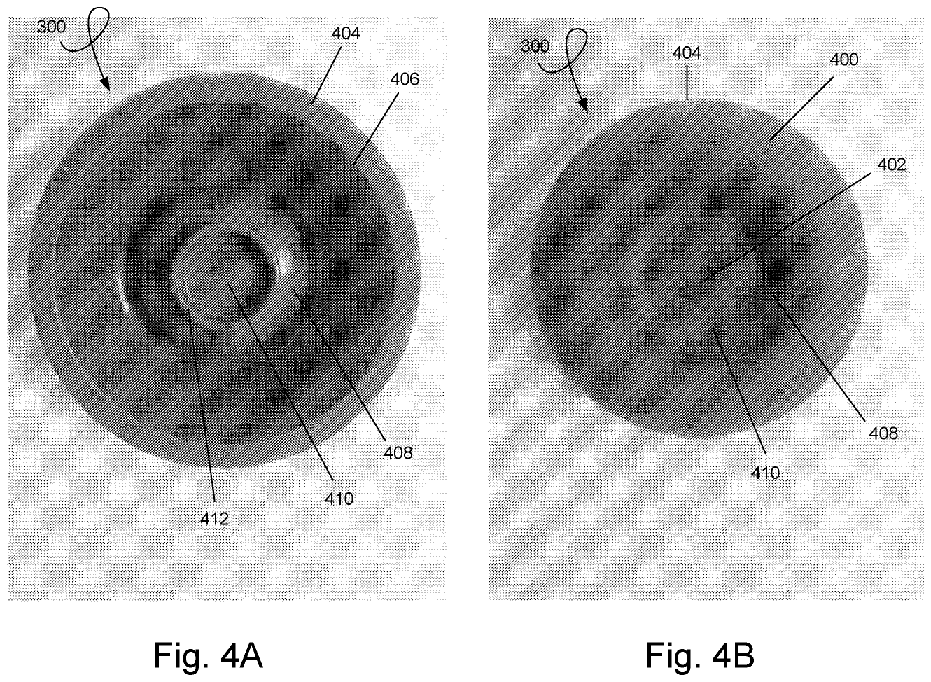

FIGS. 4A and 4B illustrate a rear view and a front view of an example of a cup region 300, respectively. As shown in FIG. 4B, the cup region 300 may comprise a ring portion 400. The ring portion 400 may be configured to apply a direct force to the skin of a recipient. The cup region 300 may also include a cavity portion 402. The cavity portion 402 may be formed within the ring portion 400. The cavity portion 402 may be configured to apply an indirect force to the skin of a recipient. The cavity portion 402 may supply an indirect force using air pressure. For example, air may collect in the cavity and create an indirect force effect when the cavity is positioned over the skin of a recipient.

As shown in FIG. 4B, the ring portion 400 may have a bottom edge 404. As shown in FIG. 4A, the ring portion 400 may include a circular lip 406 at the bottom edge 404 of the ring portion 400. The lip 406 may be configured to engage a circumferential edge 508 of the inner frame 302. The cup region 300 may include sidewalls 408. The sidewalls may be positioned concentrically within the ring portion 400. The cavity 402 in the cup region 300 may include a bottom wall 410. In one example embodiment, the cavity portion 402 may include a substantially cylindrical sidewall extending away from the ring portion 400 and a substantially circular bottom wall connected to a sidewall portion, with the substantially circular bottom wall being concentrically within the sidewall portion, and the sidewall portion being concentrically within the ring portion 400. In another embodiment, the cavity portion 402 may be bowl shaped, with the sidewall 408 sloping away from the ring portion 400 to a flat bottom wall 410.

As shown in FIG. 4A, the cup region 300 may also include a circular engagement feature 412. The circular engagement feature 412 may be formed in one embodiment as a circular flange on the bottom of the bottom wall 410. The engagement feature 412 may also be a flange of a different shape. For example, the engagement feature 412 may be a square, triangular, or hexagonal flange or any other appropriate flange shape. In another embodiment, the engagement feature 412 may be one or more small pegs configured to fit within corresponding small holes. Alternatively, the engagement feature 412 may be one or more small holes configured to accept corresponding small pegs.

The circular engagement feature 412 may be on the rear side of the cup region 300. The inner frame 302 may be attached to the cup region 300 at the rear side of the cup region 300, where the circular engagement feature 412 is located. The circular engagement feature 412 may be configured to engage a corresponding feature 502 on the inner frame 302. The corresponding feature 502 may be a formed in one embodiment as a circular flange. The corresponding feature 502 may also be a flange of a different shape. For example, the corresponding feature 502 may be a square, triangular, or hexagonal flange or any other appropriate flange shape. In another embodiment, the corresponding feature 502 may be one or more small pegs configured to fit within corresponding small holes. The one or more small holes may be the engagement feature 412. Alternatively, the corresponding feature 502 may be one or more small holes configured to accept corresponding small pegs. The one or more small pegs may be the engagement feature 412.

In an example embodiment, the cup region 300 may have a diameter of approximately 6 cm. In an example embodiment, the cavity portion 404 may have a diameter of approximately 3 cm.

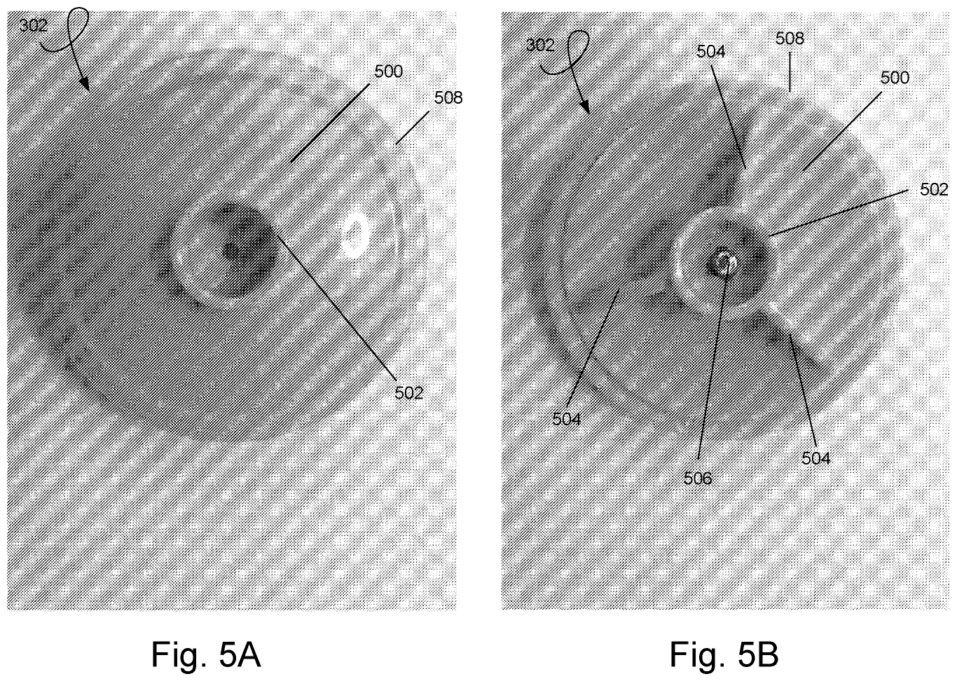

FIGS. 5A and 5B illustrate front and rear views of an example of an inner frame 302, respectively. As shown, the inner frame 302 may form a substantially circular body that bends away from the cup region 300 to present a convex surface 500 to the cup region 300. As shown in FIG. 5B, the inner frame 302 may also include an engagement feature 502, formed in one embodiment as a circular flange on the bottom of the inner frame. The engagement feature 502 may also be a flange of a different shape. For example, the engagement feature 502 may be a square, triangular, or hexagonal flange or any other appropriate flange shape. In another embodiment, the engagement feature 502 may be one or more small pegs configured to fit within corresponding small holes. The one or more small holes may be the engagement feature 412. Alternatively, the engagement feature 502 may be one or more small holes configured to accept corresponding small pegs. The one or more small pegs may be the engagement feature 412. The inner frame 302 may also include a plurality of strengthening ribs 504 that extend radially outward from the engagement feature 502 on the inner frame 302.

The inner frame 302 may also include a fastening means 506. For example, the fastening means 506 may be a threaded fastener. The fastening means 506 may also be a screw. The fastening means 506 may also be a magnetic connector. The fastening means 506 may also be a rod configured to be secured within a complementary suction chamber. In another example, the fastening means 506 may be a screw. The fastening means 506 may also be some other appropriate type of fastening means. The fastening means 506 may be configured to releasably attach the inner frame 304 to an electronic percussive massager. The inner frame 302 may be connected to the cup region 300 such that together these two components form the cup attachment 204. Therefore, the fastening means 506 may connect the entire cup attachment 204 to the electronic percussive massager.

In an example embodiment, the cup attachment may be configured to be percussed back and forth at an amplitude of from approximately 3 mm to approximately 20 mm. In an example embodiment, the cup attachment may be configured to be percussed back and forth at a frequency of from approximately 20 Hz to approximately 50 Hz.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “include” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. Where this document refers to technologies that would be apparent or known to one of ordinary skill in the art, such technologies encompass those apparent or known to the skilled artisan now or at any time in the future.

The terms “substantially” and “approximately” used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

What is claimed is:

1. A cup attachment comprising:
an elastomeric cup region, the cup region comprising:
a ring portion,
a cavity portion within the ring portion, and
a cup engagement feature, the engagement feature located on a rear side of the cup region, opposite the cavity portion;
a rigid inner frame, the inner frame comprising a frame engagement feature configured to engage the cup engagement feature to attach the inner frame to the cup region, wherein the cup region surrounds the rigid inner frame; and
a fastening means connected to the inner frame and configured to attach the cup attachment to a massage device.

2. The cup attachment of claim 1, wherein the cup region comprises rubber.

3. The cup attachment of claim 1, wherein the cup region comprises an artificial elastomer.

4. The cup attachment of claim 1, wherein the inner frame comprises a thermoplastic polymer.

5. The cup attachment of claim 4, wherein the inner frame comprises acrylonitrile butadiene styrene (ABS).

6. The cup attachment of claim 1, wherein the inner frame comprises a substantially circular body that bends away from the cup region in order to present a convex surface to the cup region.

7. The cup attachment of claim 1, wherein the inner frame further comprises a plurality of strengthening ribs that extend radially outward from the frame engagement feature on the inner frame.

8. The cup attachment of claim 1, wherein the fastening means has a configuration that enables the inner frame to be releasably attached to an electronic percussive massager.

9. The cup attachment of claim 1, wherein:
the ring portion further comprises a bottom edge and a circular lip, the circular lip being formed at the bottom edge of the ring portion;
the inner frame further comprises a circumferential edge; and
the circular lip of the ring portion engages the circumferential edge of the inner frame.

10. The cup attachment of claim 9, wherein the cavity portion further comprises:
a substantially cylindrical sidewall concentrically within and extending away from the ring portion; and
a substantially circular bottom wall connected to and concentrically within the sidewall.

11. The cup attachment of claim 9, wherein the cavity portion forms a bowl-shaped cavity such that a sidewall of the cavity portion slopes away from the ring portion to a flat bottom wall.

12. The cup attachment of claim 1, wherein:
the cup region has an outer diameter of about 6 cm; and
the cavity portion has an outer diameter of about 3 cm.

13. The cup attachment of claim 1, wherein the cup attachment has a configuration enabling percussion back and forth at an amplitude ranging from about 3 mm to about 20 mm.

14. The cup attachment of claim 1, wherein the cup attachment has a configuration enabling percussion back and forth a frequency ranging from about 20 Hz to about 50 Hz.

15. A cupping system comprising:
an electronic percussive massager, the massager comprising:
a handle portion,
a head portion distal to the handle portion, and
an attachment portion located on the head portion; and
a cup attachment, the cup attachment comprising:
an elastomeric cup region, the cup region comprising:
a ring portion,
a cavity portion within the ring portion, and
a cup engagement feature, the engagement feature located on a rear side of the cup region, opposite the cavity portion;
a rigid inner frame, the inner frame comprising a frame engagement feature configured to engage the cup engagement feature to attach the inner frame to the cup region, wherein the cup region surrounds the rigid inner frame; and
a fastening means connected to the inner frame and configured to attach the cup attachment to the massager.

16. The system of claim 15, wherein:
the cup region has an outer diameter of about 6 cm; and
the cavity portion has an outer diameter of about 3 cm.

17. The system of claim 15, wherein the cup attachment has a configuration enabling percussion back and forth a frequency ranging from about 20 Hz to about 50 Hz.

18. A cupping method comprising:
attaching a cupping attachment to an electronic percussive massager, the cupping attachment comprising:
an elastomeric cup region, the cup region comprising:
a ring portion,
a cavity portion within the ring portion, and
a cup engagement feature, the engagement feature located on a rear side of the cup region, opposite the cavity portion;
a rigid inner frame, the inner frame comprising a frame engagement feature configured to engage the cup engagement feature to attach the inner frame to the cup region, wherein the cup region surrounds the rigid inner frame; and
a fastening means connected to the inner frame and configured to attach the cup attachment to the massager;
applying the cup attachment to a skin area of a recipient; and
powering the massager, causing an application of force to the recipient.

19. The method of claim 18 wherein:
applying the cup attachment to the skin area of the recipient comprises applying the ring portion of the cup region to the skin area of the recipient; and
powering the massager comprises causing a direct application of force to the recipient via the ring portion.

20. The method of claim 18 wherein:
applying the cup attachment to the skin area of the recipient comprises applying the cavity portion of the cup region to the skin area of the recipient; and
powering the massager comprises causing an indirect application of force to the recipient using air pressure.
